(19) United States
(12) Patent Application Publication
(10) Pub. No.: US 2026/0074722 A1
(43) Pub. Date: Mar. 12, 2026

(54) SYSTEMS AND METHODS FOR CONVERGED POWER AMPLIFIERS

(71) Applicant: Skyworks Solutions, Inc., Irvine, CA (US)

(72) Inventors: Taesong Hwang, Camarillo, CA (US); Kun Chen, Thousand Oaks, CA (US); Zhu Liu, Camarillo, CA (US); Yu-Jui Lin, Westlake Village, CA (US)

(21) Appl. No.: 19/316,291

(22) Filed: Sep. 2, 2025

Related U.S. Application Data
(60) Provisional application No. 63/693,422, filed on Sep. 11, 2024.

(51) Int. Cl. H04B 1/04; H04B 1/44

(52) U.S. Cl. CPC H04B 1/0458; H04B 1/44

(57) ABSTRACT

Systems and methods for converged power amplifiers are disclosed. In one aspect, a radio frequency front end includes a first power amplifier configured to receive a first radio frequency signal and amplify the first radio frequency signal, a first filter configured to filter frequencies from the amplified first radio frequency signal for communication with a first communication standard, and a second filter configured to filter frequencies from the first amplified radio frequency signal for communication with a second communication standard. The front end further includes a second power amplifier configured to receive a second radio frequency signal and amplify the second radio frequency signal, a third filter configured to filter frequencies from the second amplified radio frequency signal for communication with a third communication standard, and an antenna switch configured to simultaneously electrically connect the first filter and the third filter to an antenna terminal.

### CROSS-REFERENCE TO RELATED APPLICATION(S)

This application claims the benefit of U.S. Provisional Application No. 63/693,422, filed Sep. 11, 2024. The foregoing application is hereby incorporated by reference in its entirety. Any and all applications for which a foreign or domestic priority claim is identified in the Application Data Sheet as filed with the present application are hereby incorporated by reference under 37 CFR 1.57.

### BACKGROUND

### Field

Embodiments of this disclosure relate to radio frequency front ends, and in particular, to converged power amplifiers for use in radio frequency front ends.

### Description of the Related Technology

The 5G communication standard can involve the use of multiplexing functions in radio frequency (RF) modules, for example, to support functionality such as carrier aggregation (CA) and Evolved Universal Mobile Telecommunications System (E-UTRAN), New Radio, Dual Connectivity (ENDC).

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a radio frequency front end comprising: a first power amplifier configured to receive a first radio frequency signal and amplify the first radio frequency signal, and a second power amplifier configured to receive a second radio frequency signal and amplify the second radio frequency signal; a first filter configured to filter frequencies from the amplified first radio frequency signal for communication with a first communication standard, a second filter configured to filter frequencies from the amplified first radio frequency signal for communication with a second communication standard, and a third filter configured to filter frequencies from the amplified second radio frequency signal for communication with a third communication standard; an antenna terminal electrically connected to an antenna; and an antenna switch configured to simultaneously electrically connect the first filter and the third filter to the antenna terminal.

In some embodiments, the first power amplifier includes a pair of first power amplifiers configured to output the amplified first radio frequency signal as a differential signal.

In some embodiments, the radio frequency front end further comprises: a balun having an input configured to receive the differential signal from the pair of first power amplifiers and an output configured to output the amplified first radio frequency signal as a balanced signal to the first filter and the second filter.

In some embodiments, the balun is further configured to provide loadline switching at outputs of the pair of first power amplifiers.

In some embodiments, the radio frequency front end further comprises: a capacitor coupled between the first power amplifier and the first filter; and a first switch configured to selectively electrically connect the first power amplifier to one of the first filter and the second filter, the first switch further configured to isolate the capacitor from the second filter.

In some embodiments, the radio frequency front end further comprises: an antenna switch module filter electrically connected between the antenna switch and the antenna terminal, the antenna switch module filter configured to filter frequencies commonly filtered from each of the first, second, and third communication standards.

In some embodiments, the first communication standard is 4G, the second communication standard is 2G, and the third communication standard is 5G.

In some embodiments, each of the first filter, the second filter, and the third filter includes a harmonic rejection filter configured to filter harmonic frequencies.

Another aspect is a mobile device comprising: an antenna configured to transmit and received radio frequency signals; and a front end module including a first power amplifier configured to receive a first radio frequency signal and amplify the first radio frequency signal, a first filter configured to filter frequencies from the amplified first radio frequency signal for communication with a first communication standard, a second filter configured to filter frequencies from the amplified first radio frequency signal for communication with a second communication standard, a second power amplifier configured to receive a second radio frequency signal and amplify the second radio frequency signal, a third filter configured to filter frequencies from the amplified second radio frequency signal for communication with a third communication standard, an antenna terminal electrically connected to an antenna, and an antenna switch configured to simultaneously electrically connect the first filter and the third filter to the antenna terminal.

In some embodiments, the first power amplifier includes a pair of first power amplifiers configured to output the amplified first radio frequency signal as a differential signal.

In some embodiments, the front end module further includes a balun having an input configured to receive the differential signal from the pair of first power amplifiers and an output configured to output the amplified first radio frequency signal as a balanced signal to the first filter and the second filter.

In some embodiments, the balun is further configured to provide loadline switching at outputs of the pair of first power amplifiers.

In some embodiments, the front end module further includes a capacitor coupled between the first power amplifier and the first filter, and a first switch configured to selectively electrically connect the first power amplifier to one of the first filter and the second filter, the first switch further configured to isolate the capacitor from the second filter.

In some embodiments, the front end module further includes an antenna switch module filter electrically connected between the antenna switch and the antenna terminal, the antenna switch module filter configured to filter frequencies commonly filtered from each of the first, second, and third communication standards.

In some embodiments, the first communication standard is 4G, the second communication standard is 2G, and the third communication standard is 5G.

In some embodiments, each of the first filter, the second filter, and the third filter includes a harmonic rejection filter configured to filter harmonic frequencies.

Yet another aspect is a method comprising: receiving a first radio frequency signal at a first power amplifier; amplifying the first radio frequency signal with the first power amplifier; filtering the amplified first radio frequency signal using a first filter to filter frequencies for communication with a first communication standard; filtering the amplified first radio frequency signal using a second filter to filter frequencies for communication with a second communication standard; receiving a second radio frequency signal at a second power amplifier; amplifying the second radio frequency signal with the second power amplifier; filtering the amplified second radio frequency signal using a third filter to filter frequencies for communication with a third communication standard; and simultaneously electrically connecting the first filter and the third filter to an antenna terminal switch using an antenna switch.

In some embodiments, the first power amplifier includes a pair of first power amplifiers configured to output the amplified first radio frequency signal as a differential signal.

In some embodiments, the method further comprises: receiving the differential signal at an input of a balun from the pair of first power amplifiers; and outputting the amplified first radio frequency signal from an output of the balun as a balanced signal to the first filter and the second filter.

In some embodiments, the balun is further configured to provide loadline switching at outputs of the pair of first power amplifiers.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure. In the figures:

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3 is a schematic diagram of one embodiment of a mobile device.

FIG. 4 illustrates a portion of an example front end module configured to implement ENDC in accordance with aspects of this disclosure.

FIG. 5 illustrates a portion of another example front end module configured to implement ENDC in accordance with aspects of this disclosure.

FIG. 6 illustrates a portion of another example front end module configured to implement ENDC in accordance with aspects of this disclosure.

FIG. 7 is a flow chart illustrating a technique for an example algorithm for performing ENDC in accordance with aspects of this disclosure.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

ENDC is a non-standalone (NSA) feature that enables mobile devices to access both 5G and 4G LTE networks at the same time. This can enable communication over both 5G and 4G LTE network technologies simultaneously.

Radio frequency front end (RFFE) chipsets are getting smaller and the integration of components is increasing. For example, to implement the ENDC NSA case, RFFE implementations can include an additional 4G/5G power amplifier to provide simultaneous 4G/5G communication capabilities. The additional 4G/5G power amplifier is placed inside the RFFE, creating challenges for the layout of the RFFE as well as isolation.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and introduced Phase 2 of 5G technology in Release 16. Subsequent 3GPP releases will further evolve and expand 5G technology. 5G technology is also referred to herein as 5G New Radio (NR).

### Example Communication Networks and Wireless Communication Devices

5G NR supports or plans to support a variety of features, such as communications over millimeter wave spectrum, beamforming capability, high spectral efficiency waveforms, low latency communications, multiple radio numerology, ENDC, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

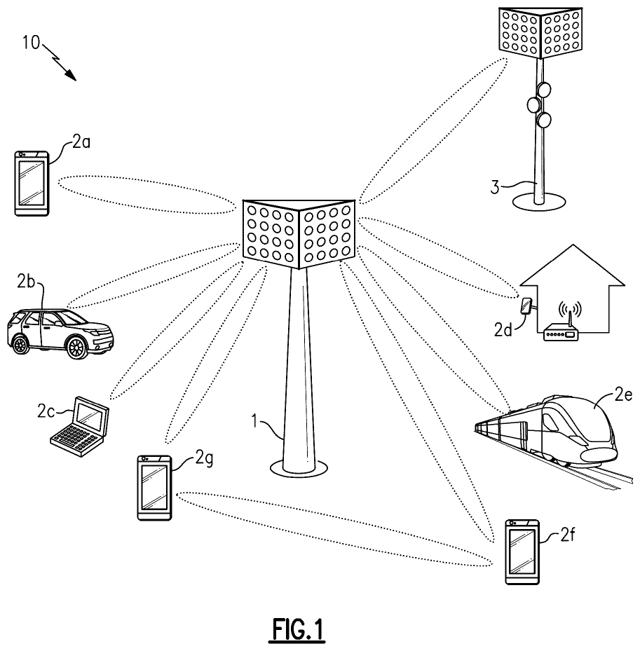

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul (for instance, as between mobile device 2g and mobile device 2f).

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1) in the range of about 410 MHz to about 7.125 GHz, Frequency Range 2 (FR2) in the range of about 24.250 GHz to about 52.600 GHz, or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

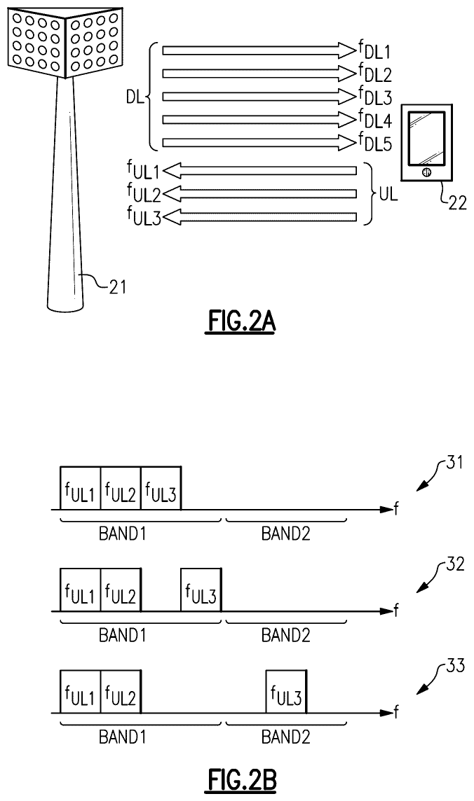

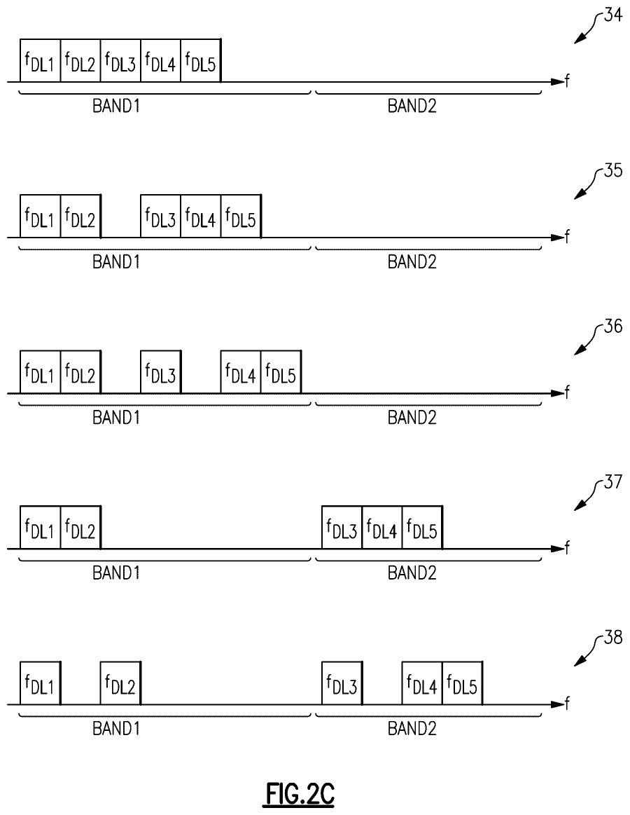

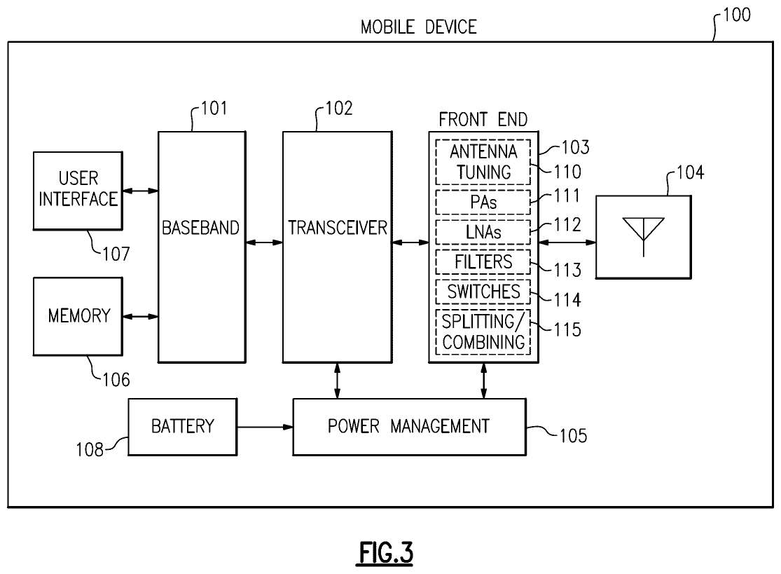

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIG. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and secondary cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink.

FIG. 3 is a schematic diagram of one embodiment of a mobile device 100. The mobile device 100 includes a baseband system 101, a transceiver 102, a front end system 103 (also referred to as a radio frequency front end), antennas 104, a power management system 105, a memory 106, a user interface 107, and a battery 108.

The mobile device 100 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 102 generates RF signals for transmission and processes incoming RF signals received from the antennas 104. It will be understood that various functionalities associated with the transmission and receiving of RF signals can be achieved by one or more components that are collectively represented in FIG. 3 as the transceiver 102. In one example, separate components (for instance, separate circuits or dies) can be provided for handling certain types of RF signals.

The front end system 103 aids in conditioning signals transmitted to and/or received from the antennas 104. In the illustrated embodiment, the front end system 103 includes antenna tuning circuitry 110, power amplifiers (PAs) 111, low noise amplifiers (LNAs) 112, filters 113, switches 114, and signal splitting/combining circuitry 115. However, other implementations are possible. For example, in some embodiments, the switches 114 are implemented in an antenna switch module (ASM) configured to electrically connect one or more of the antennas 104 to one or more of the filters 113.

For example, the front end system 103 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 100 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 104 can include antennas used for a wide variety of types of communications. For example, the antennas 104 can include antennas for transmitting and/or receiving signals associated with a wide variety of frequencies and communications standards.

In certain implementations, the antennas 104 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 100 can operate with beamforming in certain implementations. For example, the front end system 103 can include amplifiers having controllable gain and phase shifters having controllable phase to provide beam formation and directivity for transmission and/or reception of signals using the antennas 104. For example, in the context of signal transmission, the amplitude and phases of the transmit signals provided to the antennas 104 are controlled such that radiated signals from the antennas 104 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 104 from a particular direction. In certain implementations, the antennas 104 include one or more arrays of antenna elements to enhance beamforming.

The baseband system 101 is coupled to the user interface 107 to facilitate processing of various user input and output (I/O), such as voice and data. The baseband system 101 provides the transceiver 102 with digital representations of transmit signals, which the transceiver 102 processes to generate RF signals for transmission. The baseband system 101 also processes digital representations of received signals provided by the transceiver 102. As shown in FIG. 3, the baseband system 101 is coupled to the memory 106 of facilitate operation of the mobile device 100.

The memory 106 can be used for a wide variety of purposes, such as storing data and/or instructions to facilitate the operation of the mobile device 100 and/or to provide storage of user information.

The power management system 105 provides a number of power management functions of the mobile device 100. In certain implementations, the power management system 105 includes a PA supply control circuit that controls the supply voltages of the power amplifiers 111. For example, the power management system 105 can be configured to change the supply voltage(s) provided to one or more of the power amplifiers 111 to improve efficiency, such as power added efficiency (PAE).

As shown in FIG. 3, the power management system 105 receives a battery voltage from the battery 108. The battery 108 can be any suitable battery for use in the mobile device 100, including, for example, a lithium-ion battery.

### Radio Frequency Front Ends for Implementing ENDC

Depending on the standard used for radio frequency communication, two or more bands used to implement the standard may have at least partially overlapping frequencies. 5G NR introduced several ENDC cases that enable communication over two different frequency signals (e.g., 4G and 5G) at the same time.

According to 3GPP standards documents, ENDC allows user equipment to connect to an LTE enodeB that acts as a master node and a 5G gnodeB that acts as a secondary node. In effect, ENDC allows 4G LTE and 5G bandwidth to be used at the same time, and when users attempt to download content, such as a video, the speed at which that video transfers comes from both 4G LTE and 5G simultaneously. In some implements of ENDC, the user equipment front end can connect a single antenna to two receive paths, corresponding to the frequency bands use for the LTE enodeB and 5G gnodeB wireless nodes.

To support ENDC NSA cases, an additional 4G/5G power amplifier can be included in the radio frequency front end, which can create challenges for module layout and isolation. One technique for providing the additional power amplifier is to place a separate ENDC power amplifier module on the phone board. However, placing an additional module onto the phone board uses a significant amount of the available space, making this a relatively inefficient solution.

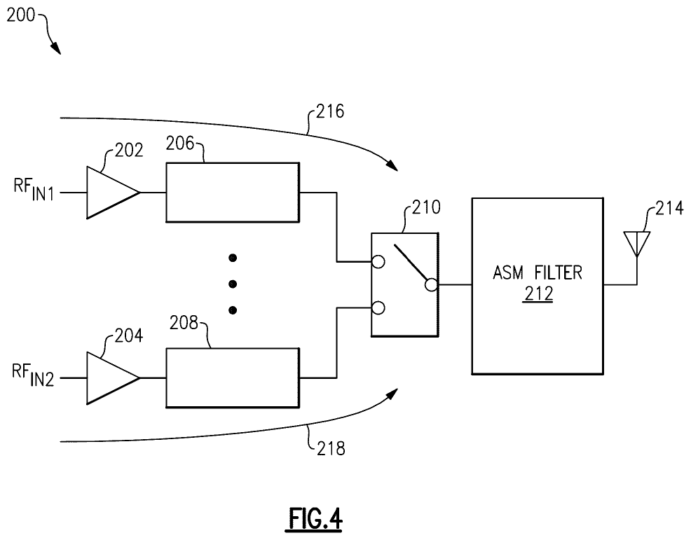

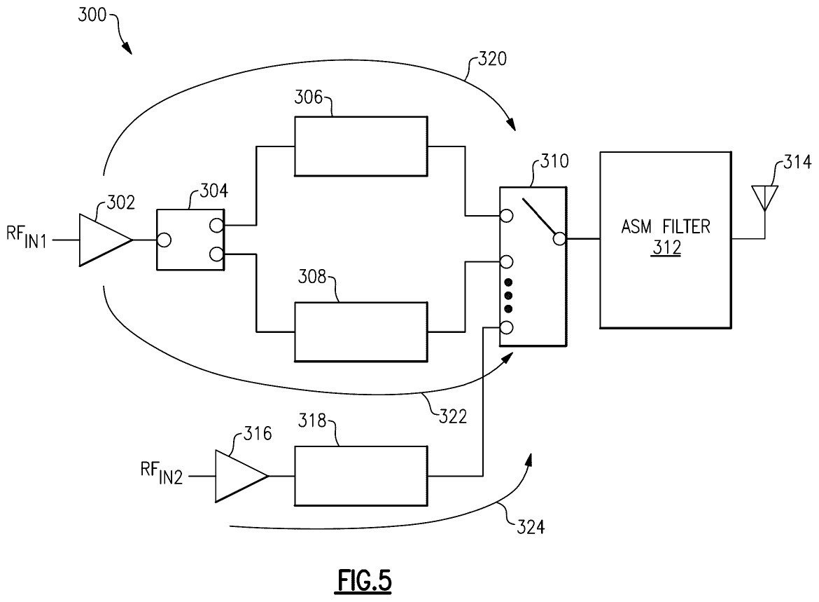

FIG. 4 illustrates a portion of an example front end module 200 configured to implement ENDC in accordance with aspects of this disclosure. As shown in FIG. 4, the front end module 200 includes a plurality of power amplifiers 202, 204, a plurality of harmonic rejection filters 206, 208 a switch 210, an antenna switch module (ASM) filter 212, and an antenna 214. Although two power amplifiers 202, 204 are illustrated in FIG. 4, the front end module 200 can include three or more power amplifiers 202, 204, each of which can be coupled to a corresponding harmonic rejection filter 206, 208.

The power amplifiers 202, 204 are configured to receive a corresponding first or second radio frequency signal RF_{IN1}, RF_{IN2}, and amplify the received radio frequency signal RF_{IN1}, RF_{IN2}. Each power amplifier 202, 204 and its corresponding harmonic rejection filter 206, 208 can be referred to as a transmit path for the corresponding first or second radio frequency signal RF_{IN1}, RF_{IN2}. For example, FIG. 4 illustrates a first transmit path 216 including the power amplifier 202 and the harmonic rejection filter 206 and a second transmit path 218 including the power amplifier 204 and the harmonic rejection filter 208.

In some embodiments, the first and second radio frequency signals RF_{IN1}, RF_{IN2} may correspond to different bands (e.g., low band, mid band, high band, etc.) or may be encoded according to different communication standards (2G, 3G, 4G, 5G, etc.). Each of the harmonic rejection filters 206, 208 is configured to filter harmonic frequencies from the amplified radio frequency signals that may interfere with communications using the corresponding communication standard. Different transmit paths may have different specifications for the amount of harmonic rejection to be provided by the corresponding harmonic rejection filters 206, 208. For example, communication using 4G or 5G standards may involve more stringent harmonic rejection compared to communication using 2G or 3G standards.

The switch 210 is configured to connect one or more of the transmit paths to the ASM filter 212. In some embodiments, the switch 210 may be configured to connect a single transmit path to the ASM filter 212, however, aspects of this disclosure are not limited thereto. For example, when implementing ENDC, two or more of the transmit paths may be connected to the ASM filter 212 simultaneously, allowing the mobile device to connect to multiple networks (e.g., 4G and 5G) at the same time.

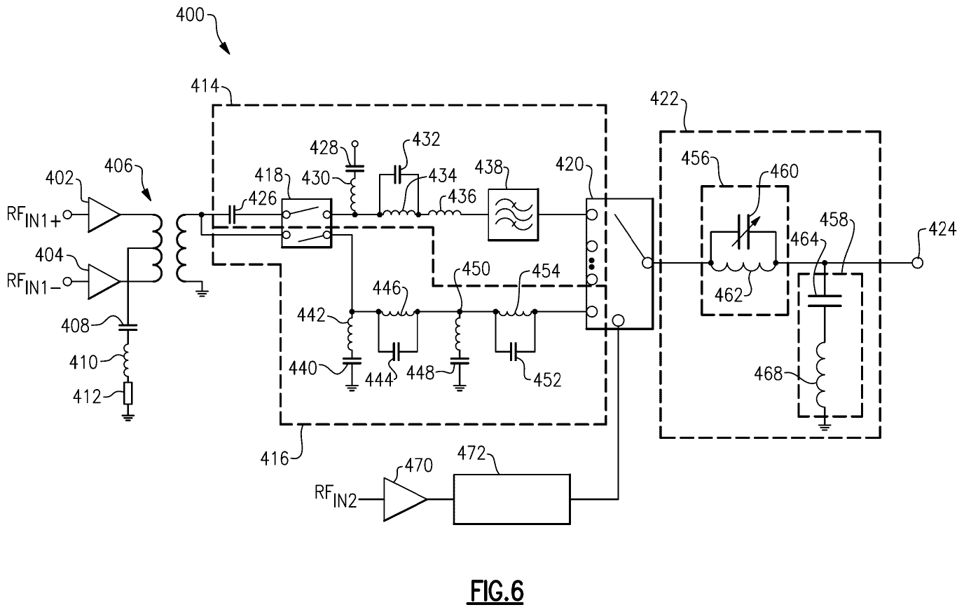

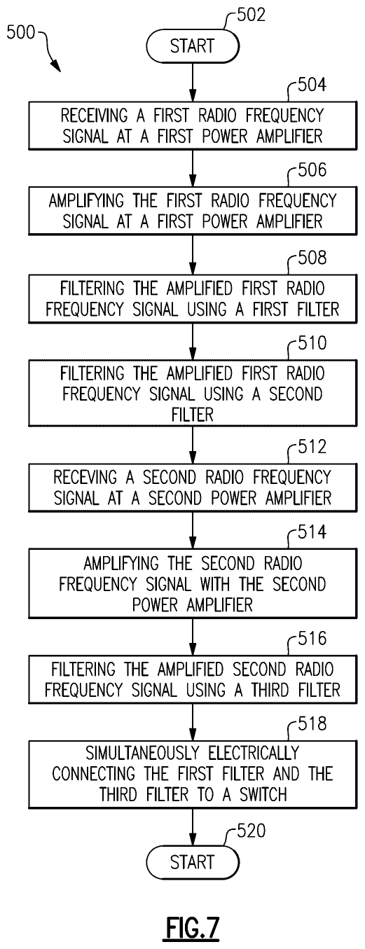

The ASM filter 212 is configured to connect the switch 210 to the antenna 214. The ASM filter 212 can be configured to filter certain frequencies which may be commonly filtered by each of the transmit paths. Although the switch 210 and the ASM filter 212 are illustrated as separate components in FIG. 4, in certain embodiments (including those of FIGS. 5 and 6 discussed below) the switch 210 and ASM filter 212 may be implemented in the same component that provides both switching and filtering capabilities.

The antenna 214 is configured to receive the first and second radio frequency signals RF_{IN1}, RF_{IN2} via the corresponding transmit paths, the switch 210 and the ASM filter 212. The antenna 214 is configured to wirelessly transmit the amplified first and second radio frequency signals RF_{IN1}, RF_{IN2} to, for example, a base station (e.g., the macro cell base station 1 or a small cell base station 3 of FIG. 1).

One design constraint for mobile devices is to reduce the layout area and number of components implementing a particular design. Thus, in some implementations, one or more transmit paths can be shared by multiple communication standards (e.g., 4G and 5G communication may share a particular transmit path) when the communication standards are not intended to be used simultaneously. However, since ENDC involves the simultaneous use of 4G and 5G communications, a mobile device configured to implement ENDC includes separate transmit paths for 4G and 5G communication.

One technique for providing separate transmit paths that can be used for ENDC (e.g., simultaneous 4G and 5G radio frequency communication) is to include a separate ENDC power amplifier module on the mobile device. However, this additional module occupies additional space and includes additional components, increasing the size of the device and cost of manufacturing the additional components.

Another technique for providing separate transmit paths that can be used for ENDC is to integrate an ENDC power amplifier inside the radio frequency front end module (e.g., inside the front end system 103 of FIG. 3). This can be accomplished, for example, by providing an additional transmit path and power amplifier in parallel with the current transmit paths and power amplifiers 202, 204 shown in FIG. 4. These embodiments can be implemented with a smaller footprint and/or fewer components than embodiments that have a separate ENDC module. However, embodiments including an additional transmit path include an additional power amplifier, which can be relatively costly and/or occupy a significant amount of space. In addition, by integrating the ENDC power amplifier the radio frequency front end module, isolation issues associated with adding an ENDC module.

FIG. 5 illustrates a portion of another example front end module 300 configured to implement ENDC in accordance with aspects of this disclosure. In contrast to the embodiment of FIG. 4, two transmit paths of the front end module 300 can be configured to share a power amplifier 302, thereby reducing the total number of components in the front end module 300.

With reference to FIG. 5, the front end module 300 includes a power amplifier 302, a first switch 304, a first harmonic rejection filter 306, a second harmonic rejection filter 308, a second switch 310, a ASM filter 312, and an antenna 314. The power amplifier 302 is configured to receive a first radio frequency signal RF_{IN1} and amplify the received first radio frequency signal RF_{IN1}. The first switch 304 is configured to couple the output of the power amplifier 302 to one of the first harmonic rejection filter 306 and the second harmonic rejection filter 308. The power amplifier 302, when coupled to each of the first and second harmonic rejection filters 306, 308, can be referred to as a transmit path. Thus, a first transmit path 320 can be formed when the switch 304 couples the power amplifier 302 to the first harmonic rejection filter 306 and a second transmit path 322 can be formed when the first switch 304 couples the power amplifier 302 to the second harmonic rejection filter 308.

The front end module 300 can further include a plurality of additional transmit paths 324, one of which is shown in FIG. 5. Each of the additional transmit paths 324 can include a power amplifier 316 configured to receive a second radio frequency signal RF_{IN2} and a harmonic rejection filter 318.

The second switch 310 is configured to connect one or more of the transmit paths 320-324 to the ASM filter 312. For example, when implementing ENDC, two or more of the transmit paths 320-324 may be connected to the ASM filter 312 simultaneously, allowing the mobile device to connect to multiple networks (e.g., 4G and 5G) at the same time.

In one example embodiment, the first harmonic rejection filter 306 is configured to filter harmonic frequencies from the amplified first radio frequency signal RF_{IN1} for communication with 4G communication, the second harmonic rejection filter 308 is configured to filter harmonic frequencies from the amplified first radio frequency signal RF_{IN1} for communication with 2G communication, and the additional harmonic rejection filter 318 is configured to filter harmonic frequencies from the amplified second radio frequency signal RF_{IN2} for communication with 5G communication. Thus, the first transmit path 320 can be configured to amplify and transmit 4G radio frequency signals, the second transmit path 322 can be configured to amplify and transmit 2G radio frequency signals, and the plurality of additional transmit paths 324 can be configured to amplify and transmit 5G radio frequency signals.

In this embodiment, the second switch 310 can be configured to simultaneously connect the first transmit path 320 and the additional transmit path 324 to the ASM filter 312 to implement ENDC. Since the front end module 300 does not need to simultaneously connect the first (4G) and second (2G) transmit paths 320 and 322 to the ASM filter 312 simultaneously, the first (4G) and second (2G) transmit paths 320 and 322 can share the same power amplifier 302, thereby reducing the footprint of the front end module 300 as well as the number of components/power amplifiers included in the front end module 300.

FIG. 6 illustrates a portion of another example front end module 400 configured to implement ENDC in accordance with aspects of this disclosure. With reference to FIG. 6, the front end module 400 includes a first power amplifier 402, a second power amplifier 404, a balun 406, a first capacitor 408, a first inductor 410, a resistor 412, a first harmonic rejection filter 414, a second harmonic rejection filter 416, a first switch 418, a second switch 420, an ASM filter 422, and an antenna terminal 424. The front end module 400 further includes a third power amplifier 470 and a third harmonic rejection filter 472.

The first and second power amplifiers 402, 404 are configured to receive a first radio frequency signal RF_{IN1}, which is illustrated as a differential signal RF_{IN1+}, RF_{IN1-} in FIG. 6. The first and second power amplifiers 402, 404 are further configured to amplify the first radio frequency signal RF_{IN1} and output the amplified first radio frequency signal RF_{IN1} to the balun 406. Together, the first and second power amplifiers 402, 404 form a converged power amplifier configured to amplify the first radio frequency signal RF_{IN1} for a plurality of communication standards. For example, in some embodiments the converged power amplifier can be configured to amplify 2G and 4G radio frequency signals. The third power amplifier 470 is configured to receive a second radio frequency signal RF_{IN2} and amplify the second radio frequency signal RF_{IN2}. In some embodiments, the third harmonic rejection filter 472 can function as a 5G harmonic rejection filter configured to filter harmonic frequencies from the amplified second radio frequency signal RF_{IN2} for communication with 5G communication.

The balun 406 is electrically connected between the first and second power amplifiers 402, 404 on a first end and the first and second harmonic rejection filters 414, 416 on a second end. The first end of the balun 406 is also coupled to ground via the first capacitor 408, the first inductor 410, and the resistor 412. Accordingly, the balun 406 has an input at the first end that receives a differential (e.g., balanced) amplified first radio frequency signal RF_{IN1} from the first and second power amplifiers 402, 404 and an output at the second end configured to output an unbalanced amplified first radio frequency signal RF_{IN1} to the first and second harmonic rejection filters 414, 416.

In some embodiments, the balun 406, the first capacitor 408, the first inductor 410, and the resistor 412 are configured to provide loadline switching at the outputs of the first and second power amplifiers 402, 404. This loadline switching supports different modulation types and also enables power amplifier array switching to ensure performance of the first and second power amplifiers 402, 404.

The first harmonic rejection filter 414 can function as a 4G harmonic rejection filter configured to filter harmonic frequencies from the amplified first radio frequency signal RF_{IN1} for communication with 4G communication. Similarly, the second harmonic rejection filter 416 can function as a 2G harmonic rejection filter configured to filter harmonic frequencies from the amplified first radio frequency signal RF_{IN1} for communication with 2G communication.

The first harmonic rejection filter 414 includes a second capacitor 426 coupled between the balun 406 and the first switch 418. Although the second capacitor 426 is illustrated as included in the first harmonic rejection filter 414, the second capacitor 426 can be considered as separate from the first harmonic rejection filter 414 in some embodiments. Similarly, FIG. 6 illustrates the first switch 418 as included in both of the first harmonic rejection filter 414 and second harmonic rejection filter 416, however, the first switch 418 can be considered as separate from the first and second harmonic rejection filters 414, 416 in some embodiments.

The first switch 418 and the second switch 420 are configured to electrically connect one of the first and second harmonic rejection filters 414, 416 between the balun 406 and the ASM filter 422. For example, the first and second switches 418, 420 can be configured to electrically connect the first harmonic rejection filter 414 to the first and second power amplifiers 402, 404 and the ASM filter 422 when communicating using 4G. In a similar fashion, the first and second switches 418, 420 can be configured to electrically connect the second harmonic rejection filter 416 to the first and second power amplifiers 402, 404 and the ASM filter 422 when communicating using 2G.

The second switch 420 can be configured to perform ENDC by simultaneously electrically connecting the first harmonic rejection filter 414 and an additional (e.g., 5G) transmit path (e.g., formed by the third power amplifier 470 and the third harmonic rejection filter 472) to the ASM filter 422. Thus, the front end module 400 can simultaneously communicate using both the 4G transmit path via the first harmonic rejection filter 414 and the additional 5G transmit path via the third harmonic rejection filter 472.

In some embodiments, the first switch 418 can be implemented as a double pole, double throw (DPDT) switch. The use of a DPDT switch for the first switch 418 can help isolate the second capacitor 426 from the second harmonic rejection filter 416 when the front end module 400 is communicating using 2G. In some embodiments, the second capacitor 426 is configured to raise the load line for the band being used for communication over the first harmonic rejection filter 414.

The first harmonic rejection filter 414 includes a third capacitor 428, a second inductor 430, a fourth capacitor 432, a third inductor 434, a fourth inductor 436, and a filter 438. In some embodiments, the filter 438 can include an acoustic wave filter, however, aspects of this disclosure are not limited thereto and the filter 438 can include other types of filters. In one example embodiment, the filter 438 can be configured to band pass frequencies for communication with band B20. When the first harmonic rejection filter 414 is used for 4G communication using band B20, the second capacitor 426 can be used to raise the loadline for band B20.

The second harmonic rejection filter 416 includes a fifth inductor 442, a fifth capacitor 440, a sixth inductor 446, a sixth capacitor 444, a seventh inductor 450, a seventh capacitor 448, an eighth inductor 454, and an eighth capacitor 452. Since the specifications for harmonic rejection for 2G may be less stringent that that of 4G, the second harmonic rejection filter 416 can be implemented without an additional filter such as the 438 (e.g., without an acoustic wave filter). Thus, in some embodiments the second harmonic rejection filter 416 can be implemented using only discrete components.

The ASM filter 422 includes a second filter 456 including a variable capacitor 460 and a ninth inductor 462 and a third filter 458 including a ninth capacitor 464 and a tenth inductor 468.

When compared to other embodiments that include additional modules and/or transmit paths, the front end module 400 of FIG. 6 can be implemented using a smaller footprint and with fewer component by using the converged power amplifier including the first and second power amplifiers 402, 404.

In some embodiments, the front end modules (e.g., the front end modules 300 and 400 of FIGS. 4 and 5) described herein can be used to share a converged power amplifier between two or more different communication standards (e.g., 2G, 4G, 5G, etc.). This can be used to reduce the area/footprint of the front end module when an additional power amplifier/transmit path would otherwise need to be added to implement ENDC.

In some embodiments, the converged power amplifier front end module can be configured to operate in a specific spectrum band. As used herein, low frequency bands may refer to frequencies below 1 GHz, mid frequency bands may refer to frequencies that range from 1 GHz-6 GHz, and high frequency bands may refer to frequencies above 6 GHz. In one example embodiment, the front end modules 300 and 400 of FIGS. 4 and 5 can be configured to operate in the low frequency bands as defined by 3GPP. However, aspects of this disclosure are not limited thereto, and the front end modules 300 and 400 of FIGS. 4 and 5 can be configured to operate in the mid or high frequency bands without departing from aspects of this disclosure.

### Example Techniques for ENDC

FIG. 7 is a flow chart illustrating a technique for an example algorithm for performing ENDC in accordance with aspects of this disclosure. With reference to FIG. 7, the ENDC technique 500 starts at block 502.

At block 504, the method 500 involves receiving a first radio frequency signal at a first power amplifier.

At block 506, the method 500 involves amplifying the first radio frequency signal with the first power amplifier.

At block 508, the method 500 involves filtering the amplified first radio frequency signal using a first filter to filter frequencies for communication with a first communication standard.

At block 510, the method 500 involves filtering the amplified first radio frequency signal using a second filter to filter frequencies for communication with a second communication standard.

At block 512, the method 500 involves receiving a second radio frequency signal at a second power amplifier.

At block 514, the method 500 involves amplifying the second radio frequency signal with the second power amplifier.

At block 516, the method 500 involves filtering the amplified second radio frequency signal using a third filter to filter frequencies for communication with a third communication standard.

At block 518, the method 500 involves simultaneously electrically connecting the first filter and the third filter to an antenna terminal switch using an antenna switch. The method 500 ends at block 520.

### Conclusion

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a stereo system, a digital music player, a radio, a camera such as a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators described herein may be embodied in a variety of other forms. Furthermore, various omissions, substitutions and changes in the form of the resonators described herein may be made without departing from the spirit of the disclosure. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio frequency front end comprising:
a first power amplifier configured to receive a first radio frequency signal and amplify the first radio frequency signal, and a second power amplifier configured to receive a second radio frequency signal and amplify the second radio frequency signal;
a first filter configured to filter frequencies from the amplified first radio frequency signal for communication with a first communication standard, a second filter configured to filter frequencies from the amplified first radio frequency signal for communication with a second communication standard, and a third filter configured to filter frequencies from the amplified second radio frequency signal for communication with a third communication standard;
an antenna terminal electrically connected to an antenna; and
an antenna switch configured to simultaneously electrically connect the first filter and the third filter to the antenna terminal.

2. The radio frequency front end of claim 1 wherein the first power amplifier includes a pair of first power amplifiers configured to output the amplified first radio frequency signal as a differential signal.

3. The radio frequency front end of claim 2 further comprising:
a balun having an input configured to receive the differential signal from the pair of first power amplifiers and an output configured to output the amplified first radio frequency signal as a balanced signal to the first filter and the second filter.

4. The radio frequency front end of claim 3 wherein the balun is further configured to provide loadline switching at outputs of the pair of first power amplifiers.

5. The radio frequency front end of claim 1 further comprising:
a capacitor coupled between the first power amplifier and the first filter; and
a first switch configured to selectively electrically connect the first power amplifier to one of the first filter and the second filter, the first switch further configured to isolate the capacitor from the second filter.

6. The radio frequency front end of claim 1 further comprising:
an antenna switch module filter electrically connected between the antenna switch and the antenna terminal, the antenna switch module filter configured to filter frequencies commonly filtered from each of the first, second, and third communication standards.

7. The radio frequency front end of claim 1 wherein the first communication standard is 4G, the second communication standard is 2G, and the third communication standard is 5G.

8. The radio frequency front end of claim 1 wherein each of the first filter, the second filter, and the third filter includes a harmonic rejection filter configured to filter harmonic frequencies.

9. A mobile device comprising:
an antenna configured to transmit and received radio frequency signals; and
a front end module including a first power amplifier configured to receive a first radio frequency signal and amplify the first radio frequency signal, a first filter configured to filter frequencies from the amplified first radio frequency signal for communication with a first communication standard, a second filter configured to filter frequencies from the amplified first radio frequency signal for communication with a second communication standard, a second power amplifier configured to receive a second radio frequency signal and amplify the second radio frequency signal, a third filter configured to filter frequencies from the amplified second radio frequency signal for communication with a third communication standard, an antenna terminal electrically connected to an antenna, and an antenna switch configured to simultaneously electrically connect the first filter and the third filter to the antenna terminal.

10. The mobile device of claim 9 wherein the first power amplifier includes a pair of first power amplifiers configured to output the amplified first radio frequency signal as a differential signal.

11. The mobile device of claim 10 wherein the front end module further includes a balun having an input configured to receive the differential signal from the pair of first power amplifiers and an output configured to output the amplified first radio frequency signal as a balanced signal to the first filter and the second filter.

12. The mobile device of claim 11 wherein the balun is further configured to provide loadline switching at outputs of the pair of first power amplifiers.

13. The mobile device of claim 9 wherein the front end module further includes a capacitor coupled between the first power amplifier and the first filter, and a first switch configured to selectively electrically connect the first power amplifier to one of the first filter and the second filter, the first switch further configured to isolate the capacitor from the second filter.

14. The mobile device of claim 9 wherein the front end module further includes an antenna switch module filter electrically connected between the antenna switch and the antenna terminal, the antenna switch module filter configured to filter frequencies commonly filtered from each of the first, second, and third communication standards.

15. The mobile device of claim 9 wherein the first communication standard is 4G, the second communication standard is 2G, and the third communication standard is 5G.

16. The mobile device of claim 9 wherein each of the first filter, the second filter, and the third filter includes a harmonic rejection filter configured to filter harmonic frequencies.

17. A method comprising:
receiving a first radio frequency signal at a first power amplifier;
amplifying the first radio frequency signal with the first power amplifier;
filtering the amplified first radio frequency signal using a first filter to filter frequencies for communication with a first communication standard;
filtering the amplified first radio frequency signal using a second filter to filter frequencies for communication with a second communication standard;
receiving a second radio frequency signal at a second power amplifier;
amplifying the second radio frequency signal with the second power amplifier;
filtering the amplified second radio frequency signal using a third filter to filter frequencies for communication with a third communication standard; and
simultaneously electrically connecting the first filter and the third filter to an antenna terminal switch using an antenna switch.

18. The method of claim 17 wherein the first power amplifier includes a pair of first power amplifiers configured to output the amplified first radio frequency signal as a differential signal.

19. The method of claim 18 further comprising:
receiving the differential signal at an input of a balun from the pair of first power amplifiers; and
outputting the amplified first radio frequency signal from an output of the balun as a balanced signal to the first filter and the second filter.

20. The method of claim 19 wherein the balun is further configured to provide loadline switching at outputs of the pair of first power amplifiers.
